(19) United States
(12) Patent Application Publication
(10) Pub. No.: US 2014/0098218 A1
(43) Pub. Date: Apr. 10, 2014

(54) MOVING CONTROL DEVICE AND AUTONOMOUS MOBILE PLATFORM WITH THE SAME

(71) Applicant: Industrial Technology Research Institute, Hsinchu (TW)

(72) Inventors: Cheng-Hua WU, Hsinchu (TW); Meng-Ju HAN, Hsinchu (TW); Ching-Yi KUO, Hsinchu (TW)

(21) Appl. No.: 13/913,002

(22) Filed: Jun. 7, 2013

(30) Foreign Application Priority Data
Oct. 4, 2012 (TW) 101136642

(51) Int. Cl. G06K 9/00

(52) U.S. Cl. CPC G06K 9/00805
USPC 348/118

(57) ABSTRACT

A moving control device is provided, including a filtering element, an image capturing unit, a calculating unit, and a light-emitting element that emits a structured light with a predetermined wavelength. The filtering element allows the structured light to pass therethrough while filtering out without the predetermined wavelength. The filtering element is provided in a portion at a front end of the image capturing unit, such that an external image retrieved by the image capturing unit includes a first region generated as a result of the light intersecting the filtering element and a second region generated as a result of the light not intersecting the filtering element. The calculating unit performs image recognition on the first and second regions of the external image to generate identification results to allow controlling movement of an autonomous mobile platform based on the identification results.

### CROSS-REFERENCE TO RELATED APPLICATIONS

This application claims priority to Taiwanese Patent Application No. 101136642, filed on Oct. 4, 2012.

### TECHNICAL FIELD

1. Technical Field

The present disclosure relates to moving control devices, and, more particularly, to a moving control device for moving an autonomous mobile platform.

2. Background

Autonomous mobile platforms, such as Automatic Guided Vehicles (AGV), are often used in manufacturing plants and warehousing for transporting goods to save human resources and establish automated processes. In order for an AGV to “walk” automatically, a moving control device is usually installed in the AGV so as to control forward, rewind, stop, or other movements of the AGV.

Traditionally, AGVs walk on established tracks, but such an arrangement makes the walking routes of the AGV fixed and cannot be changed on demand. Tracks will have to be re-laid in order to change the routes of the AGV. Laying tracks substantially cost more money, manpower and time spent. Therefore, in recent years, automatic walking techniques have incorporated guiding methods without any fixed track routes by detecting specific signs on the ground that form fixed routes along which the AGV can walk. The locations of these specific signs can be adjusted according to needs. For example, a plurality of guiding tapes can be adhered on the ground of an unmanned warehouse or factory, and an AGV may employ a sensor for optically or electromagnetically sensing these guiding tapes, so the AGV can walk along the route formed by the guiding tapes as the guiding tapes are being detected. These guiding tapes can be removed and adhered to different locations on the ground to form different routes for the AGV to walk on.

In the automatic walking technique described above, when an obstacle is encountered on the path, the AGV must have a mechanism to inform itself that there is an obstacle ahead, and stop moving. However, such a method still has the following issues: two different sets of detection devices must be installed, which not only increases the building costs of the AGV and material costs for installing the sensor, the AGV becomes more bulky and less easy to install since it has to accommodate two sets of detection devices. Moreover, the image screen can only be used for a single identification at time.

Therefore, there is an urgent need for a single detection device with multiple detecting functions in an existing AGV that is more compact and easier to install, while improving the efficiency of transporting (or walking) and reducing the construction cost.

### SUMMARY

The present disclosure provides a moving control device and an autonomous mobile platform, such as an automatic guided vehicle (AGV) and an automatic guided platform, having the same.

The present disclosure provides a moving control device applicable to an autonomous mobile platform, which may include: alight-emitting element for emitting a structured light with a predetermined wavelength; a filtering element for allowing the structured light with the predetermined wavelength to pass through while filtering out lights without the predetermined wavelength; an image capturing unit for retrieving an external image, wherein the filtering element is provided in a portion at a front end of the image capturing unit, such that the external image retrieved by the image capturing unit includes a first region generated as a result of ambient light intersecting the filtering element and a second region generated as a result of ambient light not intersecting the filtering element; and a calculating unit for performing image recognition on the first region and the second region of the external image to generate a first identification result and a corresponding second identification result, respectively, to allow controlling movement of the autonomous mobile platform based on the first identification result and the second identification result.

The present disclosure further provides an autonomous mobile platform, which may include: a main body; and a moving control device provided on the main body. The moving control device may include: a light-emitting element for emitting a structured light with a predetermined wavelength; a filtering element for allowing the structured light with the predetermined wavelength to pass through while filtering out lights without the predetermined wavelength; an image capturing unit for retrieving an external image, wherein the filtering element is provided in a portion at a front end of the image capturing unit, such that the external image retrieved by the image capturing unit includes a first region generated as a result of ambient light intersecting the filtering element and a second region generated as a result of ambient light not intersecting the filtering element; and a calculating unit for performing image recognition on the first region and the second region of the external image to generate a first identification result and a corresponding second identification result, respectively, to allow controlling movement of the autonomous mobile platform based on the first identification result and the second identification result.

### BRIEF DESCRIPTION OF DRAWINGS

The present disclosure can be more fully understood by reading the following detailed description of the preferred embodiments, with reference made to the accompanying drawings, wherein:

FIG. 1 is a functional block diagram of a moving control device for an autonomous mobile platform of an embodiment according to the present disclosure;

FIG. 2 is a schematic diagram depicting an embodiment of the moving control device for an autonomous mobile platform according to the present disclosure;

FIG. 3 is a functional block diagram of a moving control device for an autonomous mobile platform of another embodiment according to the present disclosure;

FIGS. 4A and 4B are schematic diagrams illustrating the moving control device for an autonomous mobile platform according to the present disclosure generating corresponding external images based on the locations of the filtering element;

FIG. 5 is a diagram depicting a positional relationship between an autonomous mobile platform and a moving control device provided by the present disclosure;

FIG. 6 is a schematic diagram depicting a line-shaped laser image segmented into sub-line-shaped laser images;

FIG. 7 is a schematic diagram showing a curve that illustrates the relationship between vertical locations of the laser line and corresponding distances;

FIG. 8A is a schematic diagram depicting sub-line-shaped laser images;

FIG. 8B is a schematic diagram depicting a line-shaped laser image without the occurrence of noise;

FIG. 8C is a schematic diagram depicting a line-shaped laser image with the presence of noise; and

FIG. 9 is a schematic diagram illustrating the calculation of the vertical position of a laser light using the brightness center algorithm.

### DETAILED DESCRIPTION

In the following detailed description, for purposes of explanation, numerous specific details are set forth in order to provide a through understanding of the disclosed embodiments. It will be apparent, however, that one or more embodiments may be practiced without these specific details. In other instances, well-known structures and devices are schematically shown in order to simplify the drawing.

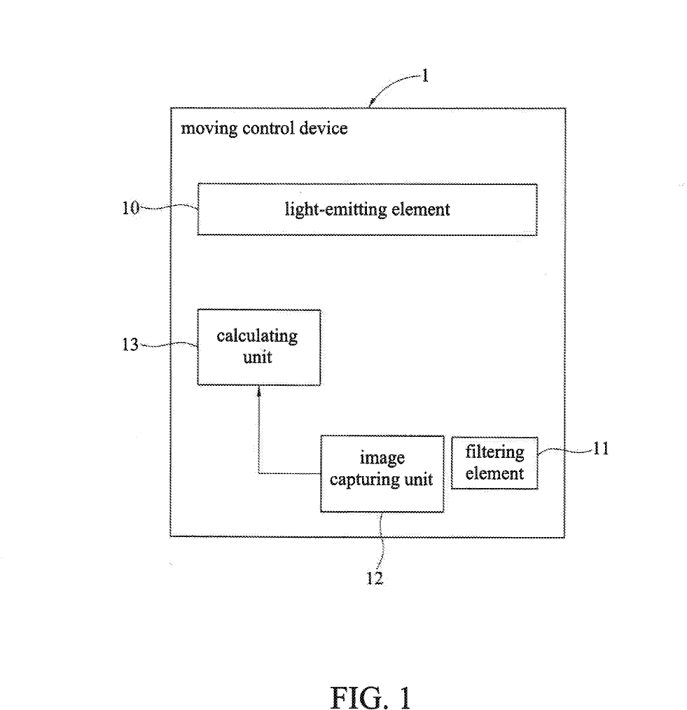

FIG. 1 is a functional block diagram of a moving control device 1 for an autonomous mobile platform, such as an automatic guided vehicle (AGV) and an automatic guided platform, of an embodiment according to the present disclosure. The moving control device 1 includes a light-emitting element 10, a filtering element 11, an image capturing unit 12, and a calculating unit 13.

The light-emitting element 10 is used for emitting a structured light with a predetermined wavelength. The filtering element 11 allows the structured light with the predetermined wavelength to pass therethrough, and filters out lights without the predetermined wavelength. In an embodiment, the structured light is near infrared with a predetermined wavelength. Since the energy of sunlight in the infrared wavelength range of 700 nm to 1400 nm is lower than in the wavelength range of 400 nm to 700 nm, the use of near infrared as the active structured light emitted by the light-emitting element 10 can resist the influence of sunlight with a smaller transmitting power. In particular, when the near infrared wavelength is in the range of about 780 nm to 950 nm, the sunlight has a small energy in the wavelength range. In other words, the use of near infrared with a specific wavelength allows the light emitting element 10 to stably emit the structured light at the minimum transmission power. The filtering element 11 may be an optical filter, a filter or optical coating. More specifically, the filter can be a low-pass filter, a high-pass filter, a band-pass filter or the like, or a combination thereof, and the present disclosure is not limited thereto. In other words, the filtering element 11 in an embodiment can be an optical filter, a filter or a optical coating with a wavelength range of 780 nm to 950 nm.

The image capturing unit 12 is used for capturing an external image. A part of the front end of the image capturing unit 12 is provided with the filtering element 11, such that the external image retrieved by the image capturing unit 12 has a first region formed by the intersection of the filtering element 11 and the light, and a second region formed by the light not intersecting with the filtering element 11. In an embodiment, the image capturing unit 12 is a CMOS sensing element or CCD sensing element, or a camera that employs a CMOS or CCD sensing element. Digital information about the space in front of the moving control device 1 is obtained by the CMOS or CCD sensing the light, and then converted into an external image. The external image will have a first region and a second region as a result of the filtering element 11.

The calculating unit 13 is connected to the image capturing unit 12 to receive the external image, and perform image recognition on the first region and the second region of the external image to produce a corresponding first identification result and a second identification result, respectively, so that the autonomous mobile platform can carry out moving control based on the first identification result and the second identification result.

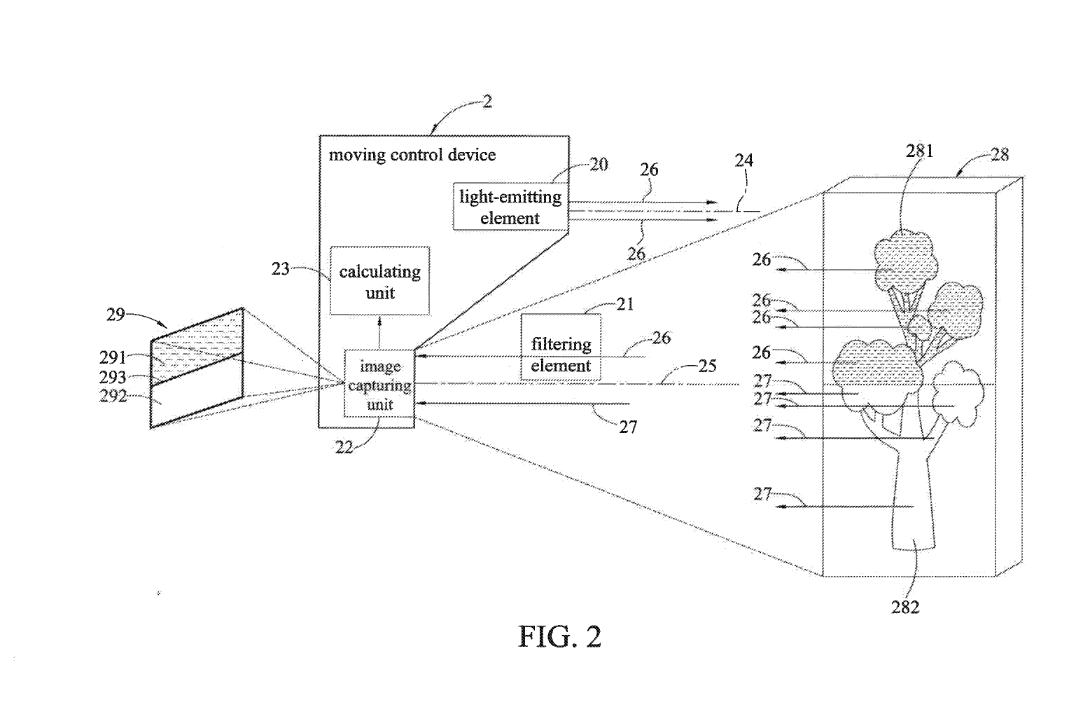

FIG. 2 is a schematic diagram depicting an embodiment of the moving control device 2 according to the present disclosure. A light-emitting element 20 emits structured light 26 of a predetermined wavelength. A filtering element 21 allows the structured light 26 to pass therethrough and filters out lights without the predetermined wavelength. In an embodiment, the wavelength of the structured light 26 emitted by the light emitting element 20 is near infrared with a wavelength of 780 nm, 830 nm or 950 nm, and the filtering element 21 is an optical filter, a band-pass filter or an optical coating that filters out light with a wavelength other than 780 nm, 830 nm or 950 nm, and allows near infrared with a wavelength of 780 nm, 830 nm or 950 nm to pass therethrough. The structured light 26 passing through the filtering element 21 and natural light 27 not passing through the filtering element 21 are retrieved by the image capturing unit 22 to form an external image 29.

The optical axis 24 of the light-emitting element 20 is parallel to the optical axis 25 of the image capturing unit 22. The light-emitting element 20 and the image capturing unit 22 are facing the same direction. By contrast, in the prior art an angle must be formed between the central line of the camera and the laser line. In an embodiment, the light emitting element 20 is installed above the image capturing unit 22, and the filtering element 21 is located in front of the image capturing unit 22 on the upper half above the central line 25 of the image capturing unit 22. The image capturing unit 22 is used for capturing the image of a front space 28 in the direction of travelling of the autonomous mobile platform. The front space 28 is divided into an upper half of the front space 281 and a lower half of the front space 282. The structured light 26 generated by the light emitting element 20 may be a point light source or a line light source, such as a linear light source. The present disclosure is not limited to the light emitting element 20 only emitting one linear light source, and may emit a plurality of linear light sources. The structured light 26 is described herein using a linear light source as an example. As the light-emitting element 20 is disposed above the image capturing unit 22, and the optical axis 24 of the light-emitting element is parallel to the optical axis 25 of the image capturing unit 22, when an obstacle appears in the front space 28 (such as a tree shown in the diagram), the linear light of the structured light 26 will only be reflected in the upper half of the front space 281, but not in the lower half of the front space 282. In other words, in the upper half scene above the central line 25 of the image capturing unit 22, only an image generated by the structured light 26 will appear. Moreover, since the natural light 27 comes from light sources, such as indoor lighting, sunlight or ambient light, in the space in which the moving control device 2 resides, the natural light 27 will appear in both the upper and lower halves of the front space.

The image capturing unit 22 when used in conjunction with the filtering element 21 can retrieve the structured light 26 reflected from the upper half of the front space 281. In an embodiment, the reflected range of the structured light 26 emitted by the light emitting element 20 can fully cover the region of the filtering element 21 for receiving the structured light 26. When the structured light 26 passes through the filtering element 21 (the structured light 26 and the filtering element 21 are intersected), light-sensed digital information of the upper half of the front space 281 is obtained by the image capturing unit 22, which in turn generates a first region 291 of the external image 29. In other words, the first region 291 of the external image 29 is the infrared image generated after the near infrared passing through the filtering element 21 is converted to the image capturing unit 22. A second region 292 of the external image 29 is generated by the natural light 27 reflected from the lower half of the front space 282. Thus, the second region 292 of the external image 29 is an image in the range of ordinary natural light generated after converting the natural light 27 directly entering into the image capturing unit 22.

In the present embodiment, the first region 291 is specifically the upper half of the external image 29 above a dividing line 293, while the second region 292 is specifically the lower half of the external image 29 below the dividing line 293. The external image 29 is consisted of the first region 291 and the second region 292 as a result of the filtering element 21 being provided in front of the image capturing unit 22 in the upper half of the image capturing unit above the central line 25. In other words, the present disclosure uses the location of the filtering element 21 to control the range of the first region 291 in the external image 29. The external image 29 is transmitted to the calculating unit 23 for calculation, i.e., for performing image recognition on the first region 291 of the external image 29 to produce the first identification result and performing image recognition on the second region 292 of the external image 29 to produce the second identification result. The first region 291 of the external image 29 is the infrared image generated by retrieving the near infrared. Upon finding an obstacle in the infrared image, the distance between the obstacle and the autonomous mobile platform can be calculated. Therefore, the first identification result is distance information between the autonomous mobile platform and an obstacle calculated by using the infrared image of the first region 291. This distance information is then used for automatically guiding the autonomous mobile platform to avoid the obstacle. In addition, the second region 292 of the external image 29 is an image in the range of ordinary natural light generated by retrieving the natural light 27. This image in the range of ordinary natural light can be used for image recognition or facial recognition. Take image recognition as an example, the second identification result may be the identification of colored tapes on the ground on which the autonomous mobile platform resides. By determining a vector path of the colored tapes on the ground, the traveling direction of the autonomous mobile platform can be automatically guided. In other words, the second identification result can be used in navigation of the autonomous mobile platform. The second identification result is not limited to the identification of colored tapes, but may include the identification of other signs for guiding the autonomous mobile platform, such as the direction indicated by an arrow, or identification of specific parts in the image, such as facial recognition and the like; the present disclosure is not limited as such. In summary of the above, the autonomous mobile platform can avoid obstacles based on the first identification result while navigating based on the second identification result, thus achieving the goal of simultaneously providing multiple moving control functions such as distance measuring and tracking by a single detecting device.

In a specific embodiment, the structured light with a predetermined wavelength is a line-shaped laser. The line-shaped laser is parallel to the horizontal plane corresponding to the image capturing unit 22. The first identification result is the distance from the autonomous mobile platform to an obstacle in the front space 28 estimated based on a line-shaped laser image received by the image capturing unit 22 using a distance sensing method.

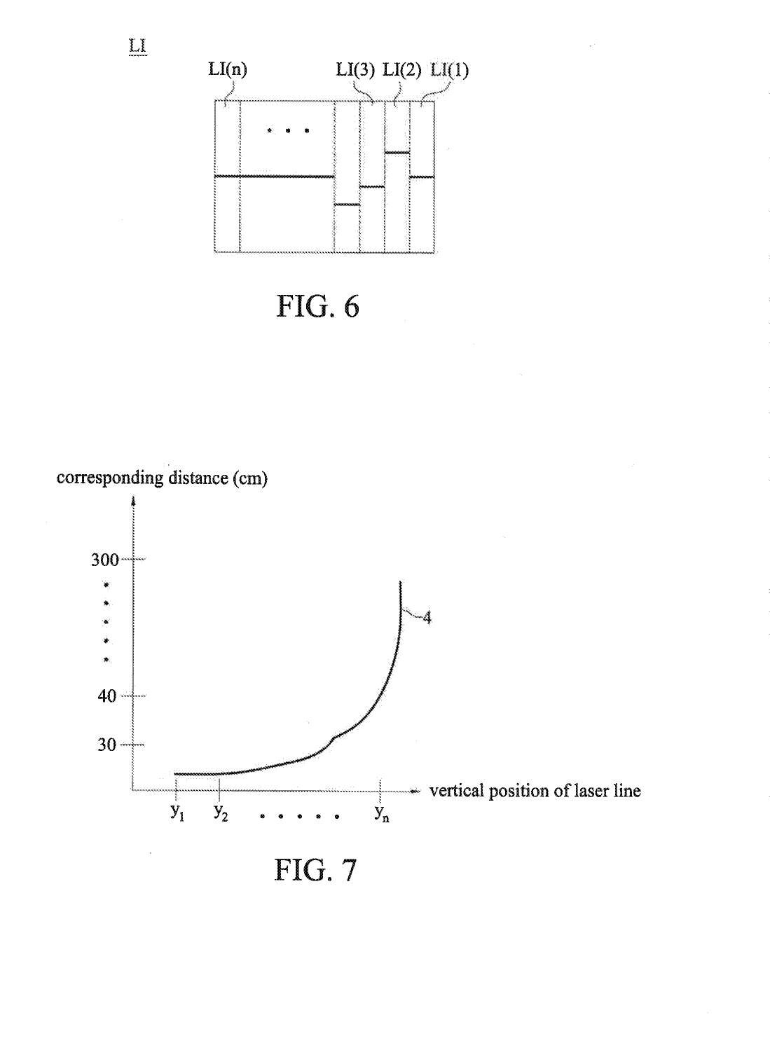

Referring in conjunction to FIGS. 6 and 7, FIG. 6 is a schematic diagram depicting a line-shaped laser image segmented into sub-line-shaped laser images, and FIG. 7 is a schematic diagram showing a curve that illustrates the relationship between vertical locations of the laser line and corresponding distances. The distance sensing method includes the following steps:

1). The calculating unit 23 receives a line-shaped laser image LI;

2). The calculating unit 23 segments the line-shaped laser image into a plurality of sub-line-shaped laser images LI (1)˜LI (n), wherein n is a non-zero positive integer;

3). The calculating unit 23 calculates the vertical location of the laser light in the i^{th} sub-line-shaped laser image in the sub-line-shaped laser images LI(1)˜LI(n), wherein i is a positive integer and 1≦i≦n; and

4). The calculating unit 23 outputs i^{th} distance information based on the vertical location of the laser light in the i sub-line-shaped laser image LI(i) and a conversion relationship, wherein the i^{th} distance information is, for example, the distance between the moving control device for an autonomous mobile platform 2 and an obstacle in the front space 28, and the conversion relationship is, for example, a relationship curve (as shown in FIG. 7) between vertical locations of a laser light and corresponding distances. The conversion relationship can be established in advance, for example, recording different corresponding distances and the vertical locations of a laser light measured by the moving control device for an autonomous mobile platform 2 at respective corresponding distances.

For example, the calculating unit 23 may output j^{th} distance information based on the i^{th} distance information, trigonometric functions and the height of the laser light in the i^{th} sub-line-shaped laser image LI(j) in the sub-line-shaped laser images LI(1)-LI(n).

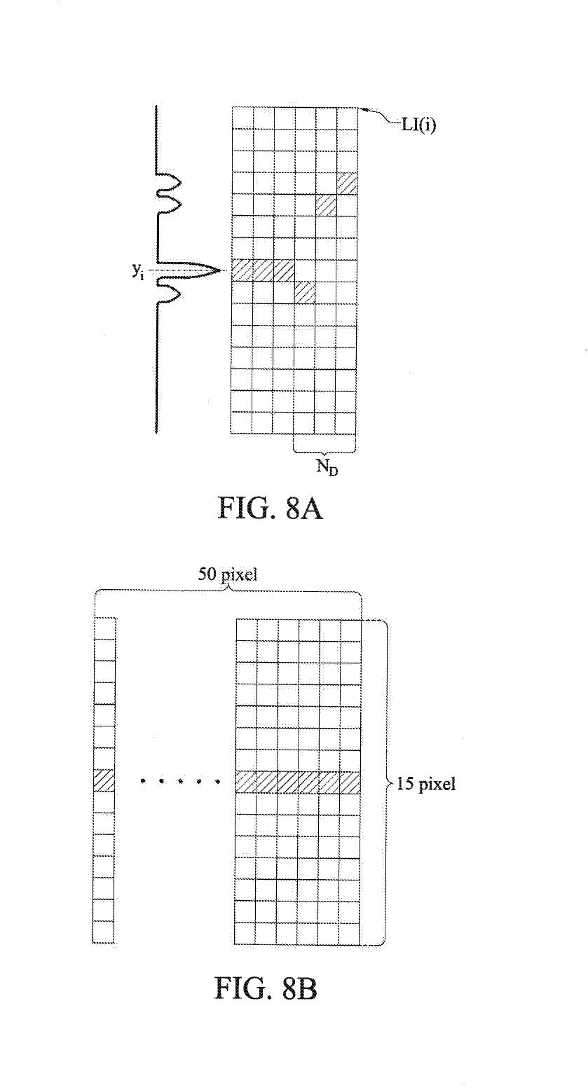

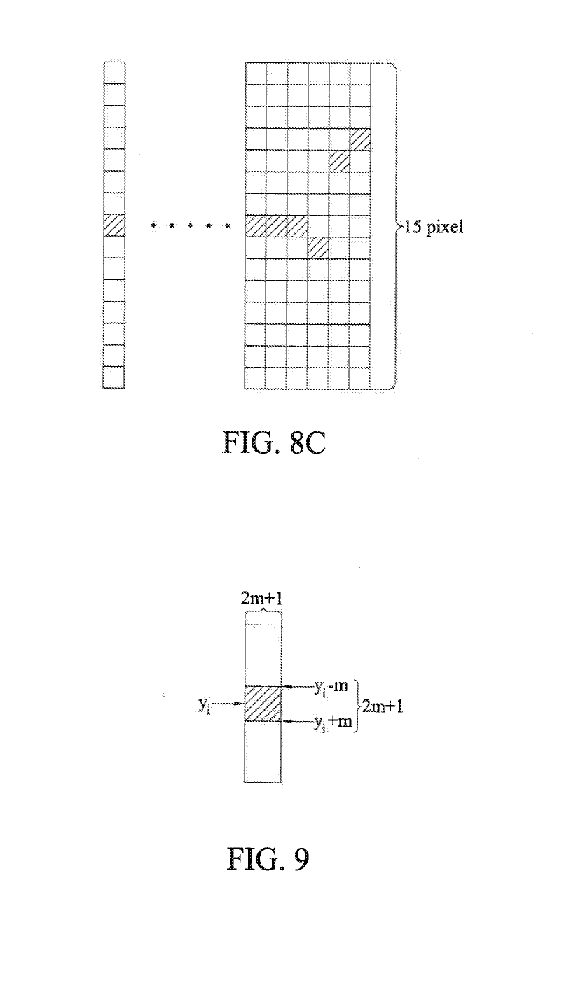

Referring in conjunction to FIGS. 6, 8A, 8B and 8C, FIG. 8A is a schematic diagram depicting sub-line-shaped laser images, FIG. 8B is a schematic diagram depicting a line-shaped laser image without the occurrence of noise, and FIG. 8C is a schematic diagram depicting a line-shaped laser image with the presence of noise. The calculating unit 23 may dynamically segment a line-shaped laser image LI based on the continuity of the laser light in the line-shaped laser image LI. In other words, the calculating unit 23 may dynamically segment the line-shaped laser image LI into sub-line-shaped laser images LI(1)-LI(n) based on each laser light segment in the line-shaped laser image LI. The widths of the sub-line-shaped laser images LI(1)˜L1(n) may vary with the lengths of the laser line segments. For example, the calculating unit 23 may determine if there is any change in the vertical location of the laser light. The calculating unit 23 groups consecutive regions with the same vertical location into a sub-line-shaped laser image. If a change occurs in the vertical location of the laser light, then the calculating unit 23 starts counting from the discontinuity of the vertical position of the laser light, and then groups consecutive regions with the same new vertical location of the laser light into another sub-line-shaped laser image. Alternatively, the calculating unit 23 may also segment the line-shaped laser image LI into sub-line-shaped laser images LI(1)-LI(n) of equal width. For example, the calculating unit 23 determines the number n of sub-line-shaped laser images LI(1)-LI(n) to be segmented based on the width W of the line-shaped laser image LI and a maximum tolerable noise width N_{D}. The number n of sub-line-shaped laser images LI(1)-LI(n) thus equals to

$$\frac{W}{2 {N}_{D}} .$$

It should be noted that the pixels with the presence of noise generally will not exist continuously in the same horizontal position. Thus, in order to avoid misjudging noise as a line-shaped laser, in actual practice, the maximum tolerable noise width N_{D} can be appropriately defined. When the number of consecutive light spots in a sub-line-shaped laser image is equal to or larger than the maximum tolerable noise width N_{D}, then the calculating unit 23 determines these light spots are part of the line-shaped laser. On the contrary, if the number of consecutive light spots in a sub-line-shaped laser image is less than the maximum tolerable noise width N_{D}, then the calculating unit 23 determines these light spots are part of the noise and not of the line-shaped laser. For example, assuming the maximum tolerable noise width N_{D} is 3. When the number of consecutive light spots in a sub-line-shaped laser image is greater than or equal to 3, then the calculating unit 23 determines these light spots are part of the line-shaped laser. On the contrary, when the number of consecutive light spots in a sub-line-shaped laser image is less than to 3, then the calculating unit 23 determines these light spots are part of the noise and not of the line-shaped laser. By segmenting a line-shaped laser image LI into sub-line-shaped laser images LI(1)˜LI(n), noise interference can be further reduced.

The calculating unit 23 performs a histogram statistics along the vertical direction of the i^{th} sub-line-shaped laser image LI(i) to obtain the vertical position yᵢ of the laser light in the sub-line-shaped laser image. For example, the calculating unit 23 performs a histogram statistics of the grayscale sum of pixels in each row along the vertical direction of the i^{th} sub-line-shaped laser image LI(i). When the grayscale sum of pixels in a row is greater than those of pixels in the other rows, the grayscale sum of this row is the highest. That is, the laser light segment resides on this row of pixels.

In another embodiment, in order to increase accuracy of position representation, the calculating unit 23 may further use a brightness center algorithm to calculate sub-pixels. FIG. 9 is a schematic diagram illustrating the calculation of the vertical position of a laser light using the brightness center algorithm. The calculating unit 23 uses the vertical position yᵢ of the laser light found from the histogram above as a center position, and then selects an area of (2m+1)×(W/n) pixels based on this center position, and then the coordinate of the laser spot is calculated using the coordinates and the brightness of the various pixels in this area by a method similar to that for calculating the center of gravity. Below are two equations for calculating the brightness center using the first sub-line-shaped laser image LI(i) as an example:

$$\begin{matrix}{X}_{c} = \frac{{\sum }_{i = 1}^{W / n} {\sum }_{j = {y}_{1} - m}^{{y}_{1} + m} [ {x}_{i} \times I ( {x}_{i} , {y}_{j} ) ]}{{\sum }_{i = 1}^{W / n} {\sum }_{j = {y}_{1} - m}^{{y}_{1} + m} I ( {x}_{i} , {y}_{j} )} & ( 1 ) \\ {Y}_{c} = \frac{{\sum }_{i = 1}^{W / n} {\sum }_{j = {y}_{1} - m}^{{y}_{1} + m} [ {y}_{i} \times I ( {x}_{i} , {y}_{j} ) ]}{{\sum }_{i = 1}^{W / n} {\sum }_{j = {y}_{1} - m}^{{y}_{1} + m} I ( {x}_{i} , {y}_{j} )} & ( 2 )\end{matrix}$$

In the above two equations, (X_{c}, Y_{c}) indicates the coordinate of the brightness center calculated, W is the width of the line-shaped laser image LI, n is the number of sub-line-shaped laser images, m is a positive integer, y₁ is the y-axis height of the laser light found from histogram in the first sub-linear image, (Xᵢ, Yᵢ) indicates a coordinate in the region of (2m+1)×(W/n) pixels, and I(Xᵢ, Yᵢ) indicates a corresponding brightness value. Thereafter, the calculating unit 23 replaces the vertical position y₁ of the laser light with the coordinate of the brightness center Y_{c}, and then the distance from the obstacle is calculated using this coordinate of the brightness center Y_{c}. Similarly, the coordinates of brightness center of the second sub-line-shaped laser image LI(2) to the n^{th} sub-line-shaped laser image LI(n) can be calculated using the above method.

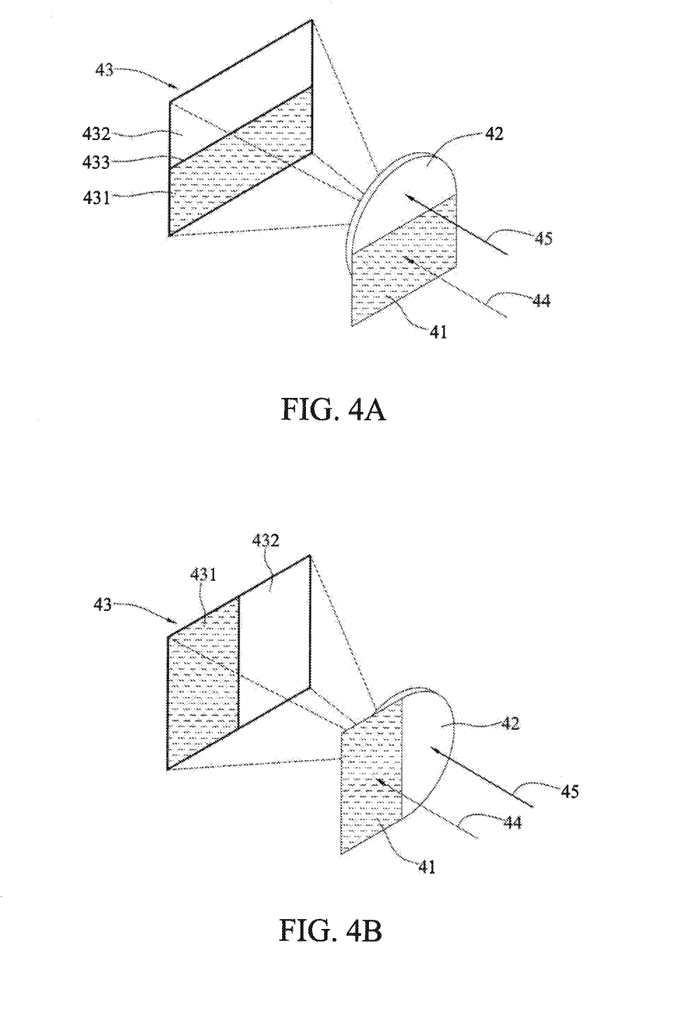

In other specific embodiments, different corresponding external images can be generated based on different locations of the filtering element. Referring to FIG. 4A, a first region 431 is the lower half of an external image 43 below a dividing line 433. This implies that a filtering element 41 is provided in front of an image capturing unit 42 in the lower half of the image capturing unit 42, such that the first region 431 consisting of infrared image generated as a result of a structured light 44 passing through the filtering element 41 and being retrieved by the image capturing unit 42 is at the lower half of the external image 43, while a second region 432 consisting of an image in the natural light range generated as a result of a natural light 45 not passing through the filtering element 41 and being directly retrieved by the image capturing unit 42 is at the upper half of the external image 43. In this embodiment, a light emitting element (not shown) is provided below the image capturing unit, so that the range after reflecting the structured light emitted by this light emitting element can fully cover a region of the filtering element 41 for receiving the structured light 44. Furthermore, the location of the filtering element 41 is used to control the range of the first region 431 of infrared image in the external image 43. Referring now to FIG. 4B, it is shown that the first region 431 and the second region 432 are the left and right halves of the external image 43, respectively. This means that the filtering element 41 is provided in the front left half of the image capturing unit 42, such that the first region 431 of infrared image generated as a result of a structured light 44 passing through the filtering element 41 and being retrieved by the image capturing unit 42 is at the left half of the external image 43, while a second region 432 consisting of an image in the natural light range generated as a result of a natural light 45 not passing through the filtering element 41 and being directly retrieved by the image capturing unit 42 is at the right half of the external image 43. In this embodiment, a light emitting element (not shown) is provided on the left of the image capturing unit, so that the range after reflecting the structured light emitted by this light emitting element can fully cover a region of the filtering element 41 for receiving the structured light 44. Nonetheless, the locations of the light emitting element and the filtering element of the present disclosure are not limited to those described above, as long as the light emitting element and the filtering element correspond to each other in such a way that the range after reflecting structured light emitted by the light emitting element can fully cover a region of the filtering element for receiving the structured light, and that the location of the filtering element can be used to control the range of the first region 431 of infrared image in the external image 43.

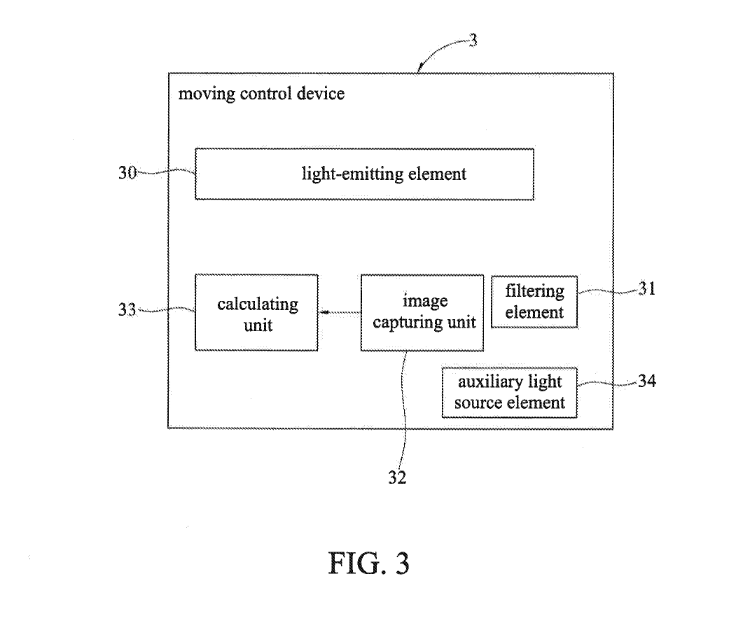

FIG. 3 is a schematic diagram depicting the structure of another embodiment of a moving control device for an autonomous mobile platform 3 of the present disclosure. The moving control device for an autonomous mobile platform 3 includes, in addition to a light emitting element 30, a filtering element 31, an image capturing unit 32, and a calculating unit 33, an auxiliary light source element 34, wherein the functions of the light emitting element 30, the filtering element 31, the image capturing unit 32, and the calculating unit 33 are the same as those described in relation to FIGS. 1 and 2, and thus will not be described again. The auxiliary light source element 34 is used to emit an auxiliary light when lighting condition during external image retrieval is too dim to enable proper image recognition of the external image retrieved. The auxiliary light source element 34 emits the auxiliary light to increase the light condition enough for the calculating unit 33 to carry out image recognition on the external image retrieved by the image capturing unit 32. In addition, the auxiliary light source element 34 may adjust the brightness, intensity or range of the auxiliary light according the lighting condition.

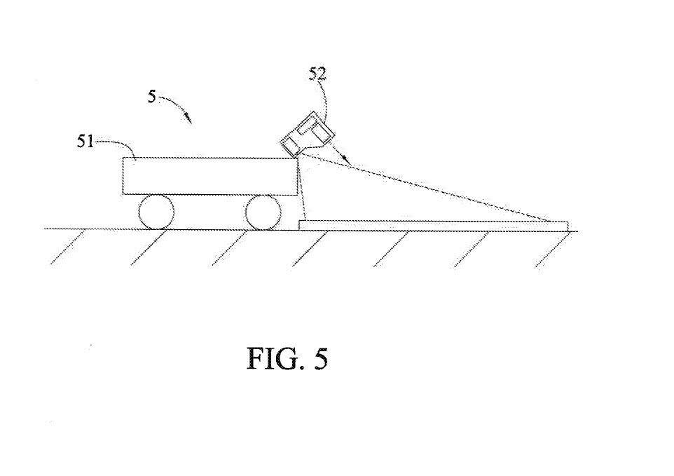

FIG. 5 is a diagram depicting a positional relationship between an autonomous mobile platform and a moving control device provided by the present disclosure. An autonomous mobile platform 5 includes a main body 51 and a moving control device 52. The moving control device 52 is provided above the main body 51. The components inside the moving control device 52 have already been described, and thus will not be repeated. As shown in FIG. 5, the moving control device 52 is provided in front of the main body 51 and tilted at a predetermined angle towards the ground, so that the image capturing unit of the moving control device 52 can retrieves images of the ground. Normally, colored tapes will be disposed on the ground for navigation use, so as long as the image areas retrieved by the moving control device 52 cover the colored tapes in front of the main body 51, the autonomous mobile platform 5 will be able to simultaneously avoid any obstacle and navigate in real time.

It will be apparent to those skilled in the art that various modifications and variations can be made to the disclosed embodiments. It is intended that the specification and examples be considered as exemplary only, with a true scope of the disclosure being indicated by the following claims and their equivalents.

What is claimed is:

1. A moving control device applicable to an autonomous mobile platform, comprising:
a light-emitting element for emitting a structured light with a predetermined wavelength;
a filtering element for allowing the structured light with the predetermined wavelength to pass therethrough while filtering out lights without the predetermined wavelength;
an image capturing unit for retrieving an external image, wherein the filtering element is provided in a portion at a front end of the image capturing unit, such that the external image retrieved by the image capturing unit includes a first region generated as a result of ambient light intersecting the filtering element, and a second region generated as a result of ambient light not intersecting the filtering element; and
a calculating unit for performing image recognition on the first region and the second region of the external image to generate a first identification result and a second identification result, respectively, to allow controlling movement of the autonomous mobile platform based on the first identification result and the second identification result.

2. The moving control device of claim 1, wherein the autonomous mobile platform estimates a distance from an obstacle to the autonomous mobile platform based on the first identification result to carry out an obstacle avoidance operation of the autonomous mobile platform.

3. The moving control device of claim 2, wherein the structured light with the predetermined wavelength is a line-shaped laser, and the first identification result is a line-shaped laser image received by the image capturing unit.

4. The moving control device of claim 3, wherein the calculating unit segments the line-shaped laser image into a plurality of sub-line-shaped laser images, and calculates vertical positions for laser lines in the sub-line-shaped laser images, and then estimates the distance from the obstacle to the autonomous mobile platform according to a conversion relationship.

5. The moving control device of claim 1, wherein the autonomous mobile platform carries out a navigation operation based on the second identification result.

6. The moving control device of claim 1, wherein the first region is an upper half of the external image above a dividing line, and the second region is a lower half of the external image below the dividing line.

7. The moving control device of claim 1, where the filtering element includes an optical filter, a filter or an optical coating.

8. The moving control device of claim 1, wherein an optical axis of the light-emitting element and an optical axis of the image capturing unit are parallel to each other and face to the same direction.

9. The moving control device of claim 1, wherein a light passing through the filtering element and entering into the image capturing unit is the structured light with the predetermined wavelength, and a light not passing through the filtering element and entering into the image capturing unit is a natural light.

10. The moving control device of claim 1, further comprising an auxiliary light source element for emitting an auxiliary light and adjusting brightness, intensity or range of the auxiliary light according to lighting condition of a space where the external image is retrieved.

11. An autonomous mobile platform, comprising:
a main body; and
a moving control device provided on the main body, including:
a light-emitting element for emitting a structured light with a predetermined wavelength;
a filtering element for allowing the structured light with the predetermined wavelength to pass through while filtering out lights without the predetermined wavelength;
an image capturing unit for retrieving an external image, wherein the filtering element is provided in a portion at a front end of the image capturing unit, such that the external image retrieved by the image capturing unit includes a first region generated as a result of ambient light intersecting the filtering element and a second region generated as a result of ambient light not intersecting the filtering element; and
a calculating unit for performing image recognition on the first region and the second region of the external image corresponding to generate a first identification result and a corresponding second identification result, respectively; to allow controlling movement of the autonomous mobile platform based on the first identification result and the second identification result.

12. The autonomous mobile platform of claim 11, wherein the moving control device is provided at a front end of the autonomous mobile platform and tilted at an angle towards a ground, such that the image capturing unit retrieves images of the ground.

13. The autonomous mobile platform of claim 11, wherein the structured light with the predetermined wavelength is a line-shape laser and the first identification result is a line-shaped laser image received by the image capturing unit.

14. The autonomous mobile platform of claim 13, wherein the calculating unit segments the line-shaped laser image into a plurality of sub-line-shaped laser images, and calculates vertical positions of laser lines in the sub-line-shaped laser images, and then estimates a distance from the obstacle to the autonomous mobile platform according to a conversion relationship.

15. The autonomous mobile platform of claim 11, wherein the first region is an upper half of the external image above a dividing line, and the second region is a lower half of the external image below the dividing line.

16. The autonomous mobile platform of claim 11, wherein an optical axis of the light-emitting element and an optical axis of the image capturing unit are parallel to each other and are faced to the same direction.

17. The autonomous mobile platform of claim 11, wherein a light passing through the filtering element and entering into the image capturing unit is the structured light with the predetermined wavelength, and a light not passing through the filtering element and entering into the image capturing unit is a natural light.

18. The autonomous mobile platform of claim 11, wherein the moving control device further includes an auxiliary light source element for emitting an auxiliary light and adjusting brightness, intensity or range of the auxiliary light according to lighting condition of a space where the external image is retrieved.
